(19) United States
(12) Patent Application Publication
(10) Pub. No.: US 2014/0365378 A1
(43) Pub. Date: Dec. 11, 2014

(54) WEB-BASED AUTOMATED BILL NEGOTIATION SYSTEM

(71) Applicant: Gregory J. Hummer, Shaker Heights, OH (US)

(72) Inventor: Gregory J. Hummer, Shaker Heights, OH (US)

(21) Appl. No.: 14/296,650

(22) Filed: Jun. 5, 2014

Related U.S. Application Data
(60) Provisional application No. 61/831,895, filed on Jun. 6, 2013.

(51) Int. Cl. G06F 19/00; G06Q 50/18

(52) U.S. Cl. CPC G06F 19/328; G06Q 50/188
USPC 705/80

(57) ABSTRACT

A system and methods for facilitating negotiation of a medical bill owed to a medical provider for a patient via a web based cloud application which automatically calculates the best settlement offer for the individual's bills. The system and method provide a bill negotiation tool which is automated and provides the best settlement offer for reducing a patient's bill owed to a medical provider.

### BACKGROUND

The subject application relates to a web-based automated bill negotiation system and method. Conventional systems and methods for negotiating a patient's bills are not automated, take enormous time out of the parties daily routine, and do not calculate the best settlement offer for a patient's bills.

Accordingly, there is an unmet need for systems and/or methods that facilitate overcoming the aforementioned deficiencies.

### BRIEF DESCRIPTION

According to one aspect, a system that facilitates negotiating a patient's bill owed to a medical provider comprises a processor that executes computer-executable instructions for calculating a settlement amount on the patient's balance bill owed to the medical provider or may offer a prospective amount to the medical provider on behalf of the patient, therewith and a memory that stores the computer-executable instructions. The system further includes a server comprising the processor and the memory and providing Internet access to the processor for calculating the settlement amount. The instructions comprise receiving patient billing information, calculating a settlement amount associated with the bill owed or an amount prospectively for the procedure to be owed to the medical provider from the patient billing information, electronically communicating the settlement amount to the associated medical provider, determining whether the medical provider accepted or declined the settlement amount, informing the patient and charging a service fee if the medical provider accepted the settlement amount, calculating a second settlement amount if the medical provider declined the settlement amount, electronically communicating the second settlement amount to the associated medical provider, determining whether the medical provider accepted or declined the second settlement amount, informing the patient and charging a service fee if the medical provider accepted the second settlement amount, and updating a bill status based on the determination of the first and second settlement amounts.

### BRIEF DESCRIPTION OF THE DRAWINGS

FIG. 1 illustrates a system for web-based automated bill negotiation, in accordance with various aspects set forth herein.

FIG. 2 illustrates a method for automated bill negotiation in accordance with various aspects described herein.

FIG. 3 illustrates a screenshot of a user interface of the automated bill negotiation system that is presented to a user, in accordance with various aspects set forth herein.

FIG. 4 illustrates another screenshot of a user interface of the automated bill negotiation system that is presented to a user, in accordance with various aspects set forth herein.

### DETAILED DESCRIPTION

In accordance with various features described herein, systems and methods are described that facilitate negotiation of a medical bill for an individual (e.g., patients and their family members, insurance customers and their family members, etc.) via a web based cloud application which automatically calculates the best settlement offer for the individual's bills. As used herein, “algorithm” or “module” refers to a set of computer-executable instructions stored on a computer-readable medium and executable by a processor or other computing device, as will be appreciated by those of skill in the art.

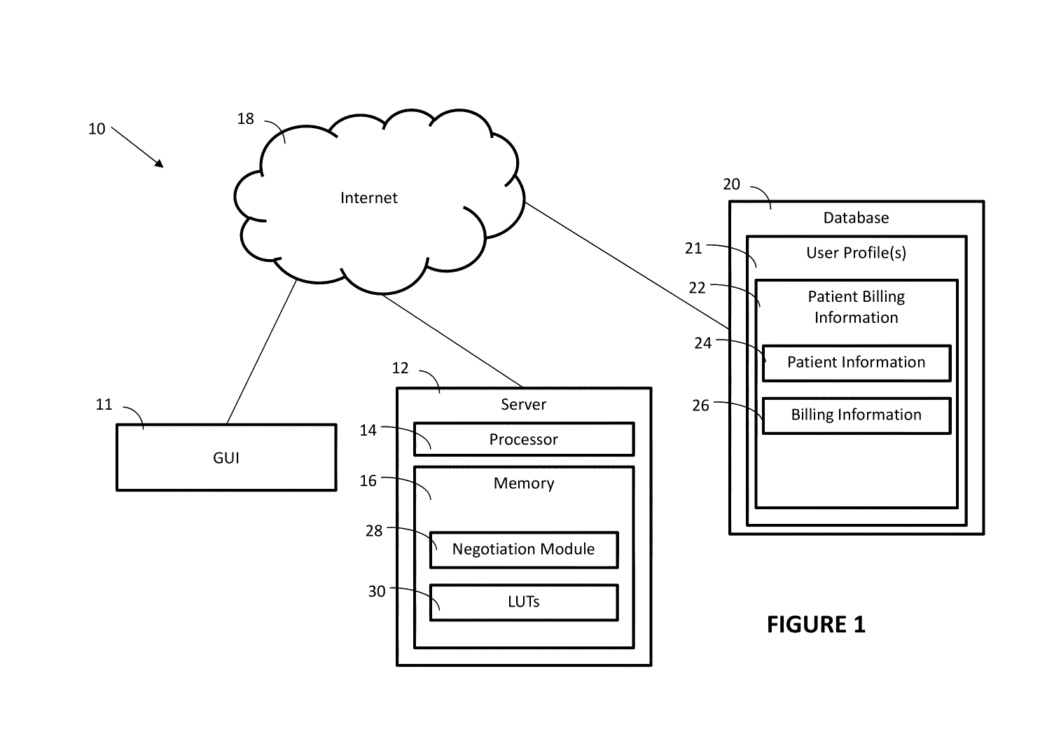

With reference to FIG. 1, a system 10 is illustrated that facilitates providing the herein-described web-based automated bill negotiation, e.g., via a graphical user interface (GUI) 11. The system 10 includes a server 12 with a processor 14 that executes, and a memory 16 that stores, computer-executable instructions for performing the various functions, methods, techniques, algorithms, etc., described herein. The server is coupled to the Internet 18, by which it communicates with, accesses, etc., the GUI 11 (e.g., a personal computer, laptop, tablet, smartphone, etc.). Additionally, the server can access a database 20 that stores user profiles 21 comprising patient billing information 22. The patient billing information 22 includes patient information 24 (e.g., patient name, patient contact information, medical provider, medical provider contact information, insurance carrier, insurance carrier account information, patient payment information, etc.) and billing information 26 (e.g., invoice number, bill amount, patient balance, date of service, negotiated amount to pay, status of the bill, due date, etc.) The patient billing information 22 may be entered by the user (e.g., via the GUI) or may be medical record data that the user has authorized to be made available to a provider of the automated bill negotiation. Although depicted as being stored in a database 20 coupled to the GUI and server via the internet, the user profile can reside on the user's GUI 11 or at any other suitable location (e.g., the server 12, a remote server or computer-readable storage device, etc.). In another embodiment, the database 20 is a distributed database and/or the server 12 is a distributed server.

The patient billing information 22 is uploaded to, or retrieved by, the server 18 and loaded into a negotiation module 28 stored in memory 16. The negotiation module 28 utilizes the patient billing information 22 to automatically secure a settlement or discount on the patient's balance bill owed to a medical provider. Specifically, the negotiation module 28 calculates a settlement amount associated for each bill included in the patient billing information 22 to provide the greatest chance of success to decrease the amount owed to the medical provider. The settlement amount is then communicated to the medical provider whom either accepts or declines the settlement amount, by clicking on Accept or Decline within the email, which then automatically updates the server data base immediately or by e-faxing the offer back to the server. If the medical provider accepts the settlement amount, the patient is then charged by the negotiation module 28 for the settlement amount. If the settlement amount is declined, the negotiation calculates another settlement amount which is communicated to the medical provider.

To accomplish this, a patient initially inputs billing information for a bill owed to a medical provider utilizing the GUI 11. Along with the billing information, the patients input patient information including payment information such as credit card information or checking account information. In another embodiment, the payment information comprises online payment service account information such as a PayPal™ account or the like. After the patient's billing and patient information have been entered, the negotiation module 28 utilizes a negotiation algorithm to calculate the best settlement amount to offer the medical provider. For example, the negotiation module 28 will calculate the settlement amount utilizing a percentage of the owed amount for each bill. In another embodiment, the negotiation module 28 determines the settlement amount utilizing a negotiation table which stores optimal settlement amounts for various balance amounts utilizing one or more lookup tables (LUT) 30. In another embodiment, the settlement amount can be user-entered values.

After the negotiation module 28 determines a settlement amount for a particular bill, the negotiation module 28 transmits an electronic communication (email, fax, automated voice phone call, etc.) which enables the medical provider to accept or decline the settlement amount. For example, an electronic mail message is sent to the medical provider with a clickable link which includes accept or decline fields. Clicking on the accept or decline link within the email automatically updates the bill's status with the medical provider response and, if accepted, directs the medical provider to another website to signature the settlement amount with a dated time stamp which is stored in the patient billing information 22. If the medical provider does not have an electronic mail account, the negotiation module 18 transmits an electronic fax message to the medical provider's fax machine. The medical provider indicates on the transmitted document whether the settlement amount is accepted or declined and faxes the document back to the negotiation module 18. The negotiation module 18 utilizes one or more word or image recognition algorithms (e.g., optical character recognition or some other suitable algorithm) to determine whether the settlement amount was accepted or declined which is updated on the bill's status.

After a settlement amount is accepted by the medical provider, the patient is electronically informed by electronic mail and has a predetermined time to pay the medical provider the settlement amount. If the settlement amount is accepted by the medical provider, the patient is charged a service fee for the service provided. The service fee can include a one-time fee, a percentage of the settlement amount, and the like. If the settlement amount is declined by the medical provider, the patient is informed electronically and the negotiation module 18 calculates a second settlement amount via the negotiation algorithm, look-up table, or user-input which is communicated to the medical provider. If the medical provider declines the second settlement amount, the patient is informed once again and is not charged the service fee.

As previously mentioned, the system 10 comprises the processor 14 that executes, and memory 16 that stores, computer-executable instructions and/or computer-readable data (e.g., a software package or product) for performing the various techniques and/or methods described herein. The memory 16 may be a computer-readable recording medium on which a control program or software product is recorded, such as a disk, hard drive, or the like. Common forms of computer-readable media include, for example, floppy disks, flexible disks, hard disks, magnetic tape, or any other magnetic storage medium, CD-ROM, DVD, or any other optical medium, a ROM, a PROM, an EPROM, a FLASH-EPROM, or other memory chip or cartridge, or any other tangible medium from which a computer can read and use. Alternatively, the methods may be implemented in a transmittable carrier wave in which the control program is embodied as a data signal using transmission media, such as acoustic or light waves, such as those generated during radio wave and infrared data communications, and the like.

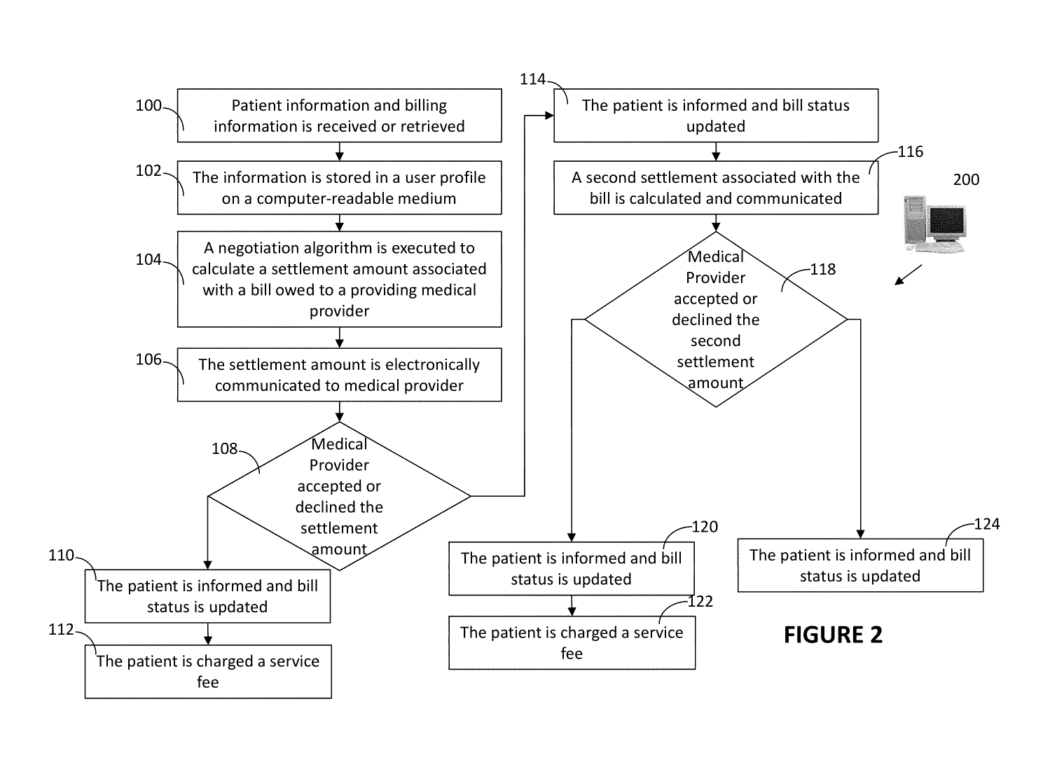

FIG. 2 illustrates a method related to automatically negotiating a settlement amount for a patient's bill owed to a medical provider, in accordance with various features. While the method is described as a series of acts, it will be understood that not all acts may be required to achieve the described goals and/or outcomes, and that some acts may, in accordance with certain aspects, be performed in an order different that the specific orders described. The method of FIG. 2 may be implemented on a computer 200, as described below. Additionally, it will be appreciated that the method of FIG. 2 may be performed separately or in conjunction with each other.

FIG. 2 illustrates a method for automated bill negotiation, such as can be performed by the system of FIG. 1, in accordance with various aspects described herein. At 100, patient information (e.g., patient name, patient contact information, medical provider, medical provider contact information, insurance carrier, insurance carrier account information, patient payment information, etc.) and billing information (e.g., invoice number, bill amount, patient balance, date of service, negotiated amount to pay, status of the bill, due date, etc.) are received or retrieved. The information is stored in a user profile for the user on a computer-readable medium, at 102. At 104, a negotiation algorithm is executed to calculate a settlement amount (e.g., a dollar amount, or some other currency amount) associated with a bill owed to a medical provider. At 106, the settlement amount is electronically communicated to the medical provider. At 108, it is determined whether the medical provider accepted or declined the settlement amount. If it is determined that the medical provider accepted the settlement amount, the patient is informed and the bill status is updated at 110. At 112, the patient is charged a service fee. If it is determined that the medical provider declined the settlement amount, the patient is informed and the bill status updated at 114. At 116, a second settlement amount associated with the bill is calculated and communicated to the medical provider. At 118, it is determined whether the medical provider accepted or declined the second settlement amount. If it is determined that the medical provider accepted the second settlement amount, the patient is informed and the bill status updated at 120. At 122, the patient is charged a service fee. If it is determined that the medical provider declined the second settlement amount, the patient is informed and the bill status updated at 124. The method thus provides a bill negotiation tool which is automated and provides the best settlement offer for reducing a patient's bill owed to a medical provider.

The method illustrated in FIG. 2 may be implemented in a computer program product that may be executed on a computer 200 or processor such as the processor 14 in the system of FIG. 1. Further, it is to be appreciated that any suitable computing environment can be employed in accordance with the present embodiments. For example, computing architectures including, but not limited to, stand alone, multiprocessor, distributed, client/server, minicomputer, mainframe, supercomputer, digital and analog can be employed in accordance with the present embodiments.

The computer can include a processing unit such as the processor 16 of FIG. 1, a system memory such as the memory 16 of FIG. 1, and a system bus that couples various system components including the system memory to the processing unit. The processing unit can be any of various commercially available processors (e.g., a central processing unit, a graphical processing unit, etc.). Dual microprocessors and other multi-processor architectures also can be used as the processing unit.

The system bus can be any of several types of bus structure including a memory bus or memory controller, a peripheral bus, and a local bus using any of a variety of commercially available bus architectures. The computer memory includes read only memory (ROM) and random access memory (RAM). A basic input/output system (BIOS), containing the basic routines that help to transfer information between elements within the computer, such as during start-up, is stored in ROM.

The computer can further include a hard disk drive, a magnetic disk drive, e.g., to read from or write to a removable disk, and an optical disk drive, e.g., for reading a CD-ROM disk or to read from or write to other optical media. The computer typically includes at least some form of computer readable media. Computer readable media can be any available media that can be accessed by the computer. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other magnetic storage devices, or any other medium which can be used to store the desired information and which can be accessed by the computer.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above can also be included within the scope of computer readable media.

A number of program modules may be stored in the drives and RAM, including an operating system, one or more application programs, other program modules, and program non-interrupt data. The operating system in the computer can be any of a number of commercially available operating systems.

A user may enter commands and information into the computer through a keyboard (not shown) and a pointing device or stylus (not shown), such as a mouse. Other input devices (not shown) may include a microphone, an IR remote control, a joystick, a game pad, a satellite dish, a scanner, or the like. These and other input devices are often connected to the processing unit through a serial port interface (not shown) that is coupled to the system bus, but may be connected by other interfaces, such as a parallel port, a game port, a universal serial bus (USB), an IR interface, etc.

A monitor (not shown), or other type of display device, may also be connected to the system bus via an interface, such as a video adapter (not shown). In addition to the monitor, a computer typically includes other peripheral output devices (not shown), such as speakers, printers etc. The monitor can be employed with the computer to present data that is electronically received from one or more disparate sources. For example, the monitor can be an LCD, plasma, CRT, etc. type that presents data electronically. Alternatively or in addition, the monitor can display received data in a hard copy format such as a printer, facsimile, plotter etc. The monitor can present data in any color and can receive data from the computer via any wireless or hard wire protocol and/or standard.

The computer can operate in a networked environment using logical and/or physical connections to one or more remote computers, such as a remote computer(s). The remote computer(s) can be a workstation, a server computer, a router, a personal computer, microprocessor based entertainment appliance, a peer device or other common network node, and typically includes many or all of the elements described relative to the computer. The logical connections depicted include a local area network (LAN) and a wide area network (WAN). Such networking environments are commonplace in offices, enterprise-wide computer networks, intranets and the Internet.

When used in a LAN networking environment, the computer is connected to the local network through a network interface or adapter. When used in a WAN networking environment, the computer typically includes a modem, or is connected to a communications server on the LAN, or has other means for establishing communications over the WAN, such as the Internet. In a networked environment, program modules depicted relative to the computer, or portions thereof, may be stored in the remote memory storage device. It will be appreciated that network connections described herein are exemplary and other means of establishing a communications link between the computers may be used.

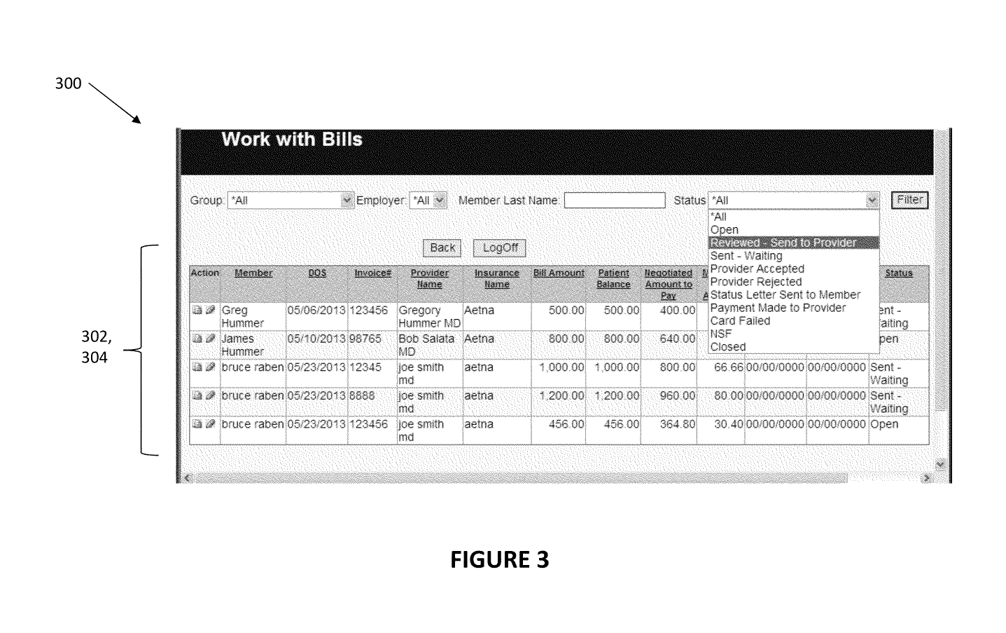

FIG. 3 illustrates a screenshot of a user interface 300 of the automated bill negotiation that is presented to a user, in accordance with various aspects set forth herein. The user interface 300 includes a personal information field 302 in which information that is entered and/or presented is displayed including but not limited to patient name, medical provider name, and insurance carrier. The user interface 300 also include a billing information field 304 in which information that is entered and/or present is displayed including but not limited to invoice number, bill amount, patient balance, date of service, negotiated amount to pay, status of the bill, due date.

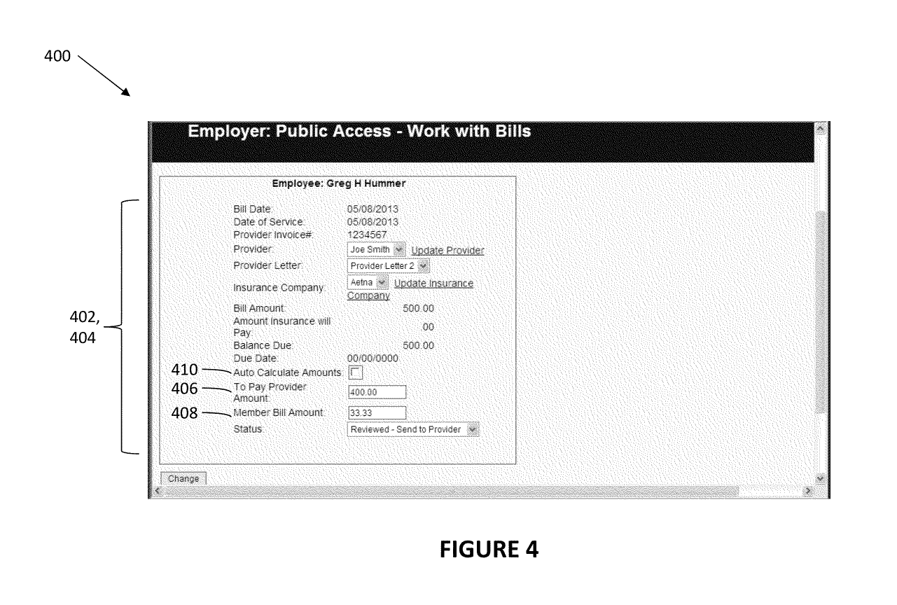

FIG. 4 illustrates another screenshot of a user interface 400 of the automated bill negotiation that is presented to a user, in accordance with various aspects set forth herein. The user interface 400 displays the patient information field 402 and billing information field 404 for a particular bill associated with a patient. The personal information field 402 including but not limited to patient name, medical provider name, and insurance carrier and the billing information field 404 including but not limited to invoice number, bill amount, patient balance, date of service, negotiated amount to pay, status of the bill, due date. The user interface 400 also includes the settlement amount to be paid 406 and a service fee amount 408. The user interface 400 also includes an auto calculate icon 410 which enables the user to have the automated bill negotiation automatically calculate the settlement amount to be presented to the medical provider.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A system that negotiates a patient's bill owed to a medical provider, comprising:
a processor that executes computer-executable instructions for calculating a settlement amount on the patient's balance bill owed to the medical provider therewith;
a memory that stores the computer-executable instructions; and
a server comprising the processor and the memory and providing Internet access to the processor for calculating the settlement amount;
wherein the instructions comprise:
receiving patient billing information;
calculating a settlement amount associated with the bill owed to the medical provider from the patient billing information;
electronically communicating the settlement amount to the associated medical provider;
determining whether the medical provider accepted or declined the settlement amount;
informing the patient and charging a service fee if the medical provider accepted the settlement amount;
calculating a second settlement amount if the medical provider declined the settlement amount;
electronically communicating the second settlement amount to the associated medical provider;
determining whether the medical provider accepted or declined the second settlement amount;
informing the patient and charging a service fee if the medical provider accepted the second settlement amount; and
updating a bill status based on the determination of the first and second settlement amounts.

2. The system according to claim 1, wherein the instructions further comprise calculating at least one of the first and second settlement amounts by identifying in a lookup table a predetermined percentage by which the bill owed is adjusted.

3. The system according to claim 1, wherein at least one of the first and second settlement amounts is a user-entered value received via a graphical user interface.

4. The system according to claim 1, wherein the instructions further comprise, upon determining that the medical provider has accepted a settlement amount, directing the medical provider to a website on which the medical provider provides a signature authorizing acceptance of the settlement amount, wherein the signature is timestamped.

5. The system according to claim 1, wherein the instructions further comprise informing the patient that the patient has a predetermined time period within which to remit payment of an accepted settlement amount.

6. The system according to claim 5, wherein upon expiration of the predetermined time period without payment by the patient, the medical provider is released from an obligation to accept the settlement amount.

7. The system according to claim 1, the instructions further comprising:
transmitting at least one of the first and second settlement amounts to the medical provider via an email comprising selectable icons for accepting and declining the transmitted settlement amount;
receiving an indication that the medical provider has selected one of the icons; and
updating a database indicate whether the transmitted settlement amount has been accepted.

8. The system according to claim 1, the instructions further comprising transmitting at least one of the first and second settlement amounts to the medical provider via electronic facsimile, and receiving a return electronic facsimile from the medical provider on which the medical provider has indicated that the transmitted settlement amount has been accepted or declined.

9. The system according to claim 8, the instructions further comprising executing an optical character recognition on the return electronic facsimile to determine whether the medical provider has accepted or declined the transmitted settlement amount.

10. The system according to claim 1, the instructions further comprising automatically charging a patient account for an accepted settlement amount upon determining that the settlement amount has been accepted by the medical provider.

11. A method for negotiating a patient's bill owed to a medical provider, comprising:
receiving patient billing information;
calculating a settlement amount associated with the bill owed to the medical provider from the patient billing information;
electronically communicating the settlement amount to the associated medical provider;
determining whether the medical provider accepted or declined the settlement amount;
informing the patient and charging a service fee if the medical provider accepted the settlement amount;
calculating a second settlement amount if the medical provider declined the settlement amount;
electronically communicating the second settlement amount to the associated medical provider;
determining whether the medical provider accepted or declined the second settlement amount;
informing the patient and charging a service fee if the medical provider accepted the second settlement amount; and
updating a bill status based on the determination of the first and second settlement amounts.

12. The method according to claim 11, further comprising calculating at least one of the first and second settlement amounts by identifying in a lookup table a predetermined percentage by which the bill owed is adjusted.

13. The method according to claim 11, wherein at least one of the first and second settlement amounts is a user-entered value received via a graphical user interface.

14. The method according to claim 11, further comprising, upon determining that the medical provider has accepted a settlement amount, directing the medical provider to a website on which the medical provider provides a signature authorizing acceptance of the settlement amount, wherein the signature is timestamped.

15. The method according to claim 11, further comprising informing the patient that the patient has a predetermined time period within which to remit payment of an accepted settlement amount.

16. The method according to claim 15, wherein upon expiration of the predetermined time period without payment by the patient, the medical provider is released from an obligation to accept the settlement amount.

17. The method according to claim 11, further comprising:
transmitting at least one of the first and second settlement amounts to the medical provider via an email comprising selectable icons for accepting and declining the transmitted settlement amount;
receiving an indication that the medical provider has selected one of the icons; and
updating a database indicate whether the transmitted settlement amount has been accepted.

18. The method according to claim 11, further comprising transmitting at least one of the first and second settlement amounts to the medical provider via electronic facsimile, and receiving a return electronic facsimile from the medical provider on which the medical provider has indicated that the transmitted settlement amount has been accepted or declined.

19. The method according to claim 18, further comprising executing an optical character recognition on the return electronic facsimile to determine whether the medical provider has accepted or declined the transmitted settlement amount.

20. The method according to claim 11, further comprising automatically charging a patient account for an accepted settlement amount upon determining that the settlement amount has been accepted by the medical provider.
